(19) United States
(12) Patent Application Publication
(10) Pub. No.: US 2017/0309105 A1
(43) Pub. Date: Oct. 26, 2017

(54) Method of Determining Currency and Denomination of an Inserted Bill in a Bill Acceptor Having a Single Slot and Related Device

(71) Applicant: LEADOT INNOVATION, INC., KAOHSIUNG (TW)

(72) Inventor: Justin Wang, Taipei City (TW)

(21) Appl. No.: 15/138,207

(22) Filed: Apr. 25, 2016

(51) Int. Cl. G07D 7/04; G07D 7/16

(52) U.S. Cl. CPC G07D 7/04; G07D 7/16

(57) ABSTRACT

A method of determining a currency type and denomination of a bill inserted into a bill acceptor includes receiving the bill inserted into the bill acceptor, the bill acceptor being a single bill acceptor accepting bills of a plurality of currency types, scanning the inserted bill after receiving the inserted bill and determining physical attributes of the inserted bill, and comparing the physical attributes of the inserted bill with attribute characteristics of entries stored in a database. The method also includes determining whether the inserted bill has a matching entry in the database, determining the currency type and denomination of the inserted bill upon determining that the inserted bill has the matching entry in the database, and indicating the determined currency type and denomination and that the inserted bill was successfully accepted in response to determining that the inserted bill has the matching entry in the database.

### BACKGROUND OF THE INVENTION

### 1. Field of the Invention

The invention relates to a bill acceptor, and more particularly, to a method of determining a currency type and a denomination of a bill inserted into a bill acceptor having a single bill acceptor slot.

### 2. Description of the Prior Art

Bill acceptors, also known as bill validators, currency detectors, currency validators, paper currency detectors, or banknote acceptors are devices used to accept inserted bills (also referred to as banknotes or paper currency) and whether the inserted bills are genuine or counterfeit. The bill acceptors also determine a denomination of the inserted bill in order to know what the monetary value of the inserted bill is.

Bill acceptors can be used in any kind of machine that accepts bills as payment, such as self-checkout machines, gaming machines, vending machines, fare collection machines, and fee collection machines such as parking fee collection machines. It is also possible to make deposits using an automated teller machine (ATM) by inserting bills through a bill acceptor that is installed in the ATM.

However, traditional bill acceptors are only capable of accepting bills of a single currency. For instance, if the bill acceptor only accepts United States dollar currency, then the bill acceptor will only accept bills in this single currency. Although many bill acceptors will accept bills of different denominations, such as $1, $5, $10, or $20, these different denomination bills are still limited to a single currency. For existing machines that do accept multiple currencies, it is necessary to have a different bill acceptor installed in the machine for each currency that is accepted. For instance, if a machine accepts both United States dollars and Euros, it is necessary to have a first bill acceptor that accepts United States dollars and a second bill acceptor that accepts Euros. The need to install multiple bill acceptors on machines in order to accept multiple currencies requires extra cost for machine manufacturers and requires additional space on the machines in which to install the multiple bill acceptors.

### SUMMARY OF THE INVENTION

It is therefore one of the primary objectives of the claimed invention to provide a bill acceptor that can accept multiple currencies using only a single bill acceptor slot.

According to an exemplary embodiment of the claimed invention, a method of determining a currency type and a denomination of a bill inserted into a bill acceptor is disclosed. The method includes receiving the bill inserted into the bill acceptor, the bill acceptor being a single bill acceptor accepting bills of a plurality of currency types; scanning the inserted bill after receiving the inserted bill and determining physical attributes of the inserted bill; comparing the physical attributes of the inserted bill with attribute characteristics of entries stored in a database; determining whether the inserted bill has a matching entry in the database; determining the currency type and the denomination of the inserted bill upon determining that the inserted bill has the matching entry in the database; and indicating the determined currency type, the determined denomination, and that the inserted bill was successfully accepted in response to determining that the inserted bill has the matching entry in the database.

According to another exemplary embodiment of the claimed invention, a multiple currency bill acceptor for determining a currency type and a denomination of an inserted bill is disclosed. The multiple currency bill acceptor includes a single bill acceptor slot receiving the inserted bill; an optical sensor scanning the inserted bill after the single bill acceptor slots receives the inserted bill and determining physical attributes of the inserted bill; a memory containing a database storing entries of attribute characteristics corresponding to a plurality of currency types and denominations; and a controller comparing the physical attributes of the inserted bill with attribute characteristics of the entries stored in a database and indicating a determined currency type, a determined denomination, and that the inserted bill was successfully accepted in response to determining that the inserted bill has the matching entry in the database.

It is an advantage that the present invention bill acceptor accepts bills of multiple currencies and multiple denominations for simplifying the design of machines that accept bills. The machines can be built less expensively using only a single bill acceptor, and less space is needed for accommodating the single bill acceptor. Furthermore, due to the flexibility and versatility of the bill acceptor, the bill acceptor can be updated in order to provide the ability to accept additional currencies, additional denominations, and new styles of bills in the future.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a bill acceptor according to the present invention.

FIG. 2 is a functional block diagram showing various sensors located within the plurality of sensors.

FIG. 3 is a diagram showing a front-right view of the bill acceptor according to a first embodiment the present invention.

FIG. 4 is a diagram showing a rear view of the bill acceptor according to the first embodiment the present invention.

FIG. 5 is a diagram showing a rear view of the bill acceptor in which a top cover of the bill acceptor is lifted according to the first embodiment the present invention.

FIG. 6 is a structural diagram showing internal components of the bill acceptor related to operation of the optical sensor according to the first embodiment of the present invention.

FIG. 7 is a flowchart describing the method of determining a currency type and a denomination of an inserted bill that is inserted into the bill acceptor according to the present invention.

### DETAILED DESCRIPTION

The present invention improves upon the prior art bill acceptor by providing a bill acceptor that can accept multiple currencies using only a single bill acceptor slot.

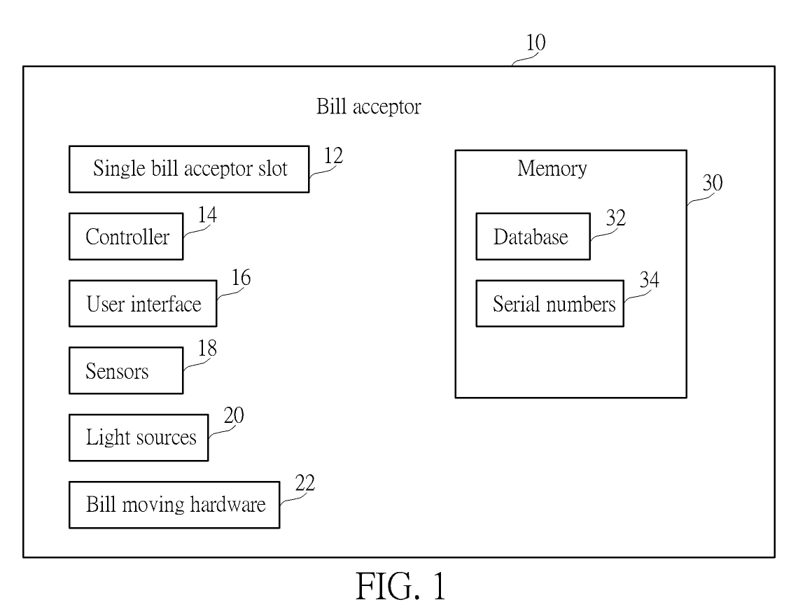

Please refer to FIG. 1. FIG. 1 is a functional block diagram of a bill acceptor 10 according to the present invention. The bill acceptor 10 contains a single bill acceptor slot 12, yet the bill acceptor 10 is still able to accept bills of multiple currencies and multiple denominations for those currencies. The single bill acceptor slot 12 should be wide enough to accommodate the width of all common currencies in order to increase the functionality of the bill acceptor 10. The bill acceptor 10 also comprises a controller 14 for controlling operation of the bill acceptor 10, a user interface 16 for allowing the user to input commands related to the operation of the bill acceptor 10, a plurality of sensors 18, a plurality of light sources 20, and bill moving hardware 22. The bill acceptor 10 also contains a memory 30 for storing a database 32 and a storage area for serial numbers 34 read from bills inserted into the bill acceptor 10. The database 32 plays a key role in the operation of the bill acceptor 10 because the database 32 stores entries for each of the different denominations and the different currencies of bills that the bill acceptor 10 is able to accept. When a bill is inserted into the bill acceptor 10, the physical attributes of the inserted bill are compared with attribute characteristics of entries stored in the database 32. There are numerous physical attributes of the inserted bill that can be checked in order to identify the inserted bill, including the physical dimensions of the inserted bill including length, width, and thickness, border dimensions, magnetic ink markings on the inserted bill, color ink markings on the inserted bill, fluorescent markings on the inserted bill, markings on the inserted bill that are sensitive to specific light bands including fiber threads of certain colors, watermarks on the inserted bill, hidden characters on the inserted bill, or small characters or markings that are too small for most people to identify with the naked eye.

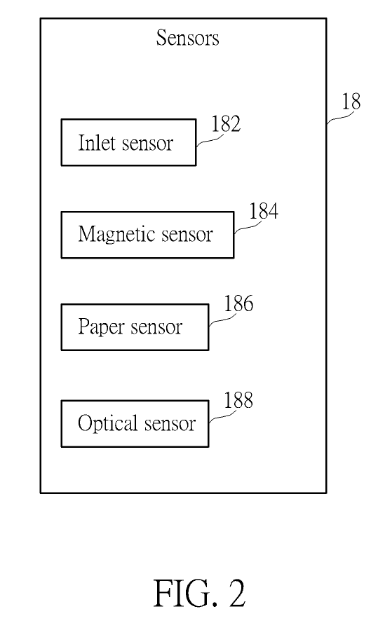

When a bill is inserted into the bill acceptor 10, the inserted bill is received and moved along with the bill moving hardware 22, and then the inserted bill is scanned using the plurality of sensors 18 in conjunction with the plurality of light sources 20. Please refer to FIG. 2. FIG. 2 is a functional block diagram showing various sensors located within the plurality of sensors 18. The plurality of sensors 18 includes an inlet sensor 182 for sensing when a bill is inserted into the single bill acceptor slot 12, a magnetic sensor 184 for sensing magnetic ink contained on the inserted bill, a paper sensor 186 for detecting properties of the paper that the inserted bill is printed on such as the thickness of the paper and a type of paper, and an optical sensor 188 for detecting optical properties of the inserted bill. Other types of sensors may be used in the bill acceptor 10, as is known by a person skilled in the art of bill acceptors. The inlet sensor 182 can detect both the beginning of the inserted bill and the end of the inserted bill. A dielectric sensor can also be used, in which the capacitance produced by the dielectric sensor changes when a bill passes through charged plates of the dielectric sensor. The magnetic sensor 184 senses magnetic ink when the magnetic ink causes the magnetic field detected by the magnetic sensor 184 to change. The optical sensor 188 can sense both visible light and invisible light such as infrared light and ultraviolet light. Different wavelengths of light can be used for sensing special marks on the bills including color ink markings, fluorescent markings, markings that are sensitive to specific light bands, watermarks, hidden characters, or small markings. Using all of the different sensors in the plurality of sensors 18, a determination can be made whether the inserted bill is genuine or counterfeit by comparing the detected physical attributes of the inserted bill with attribute characteristics of entries stored in the database 32.

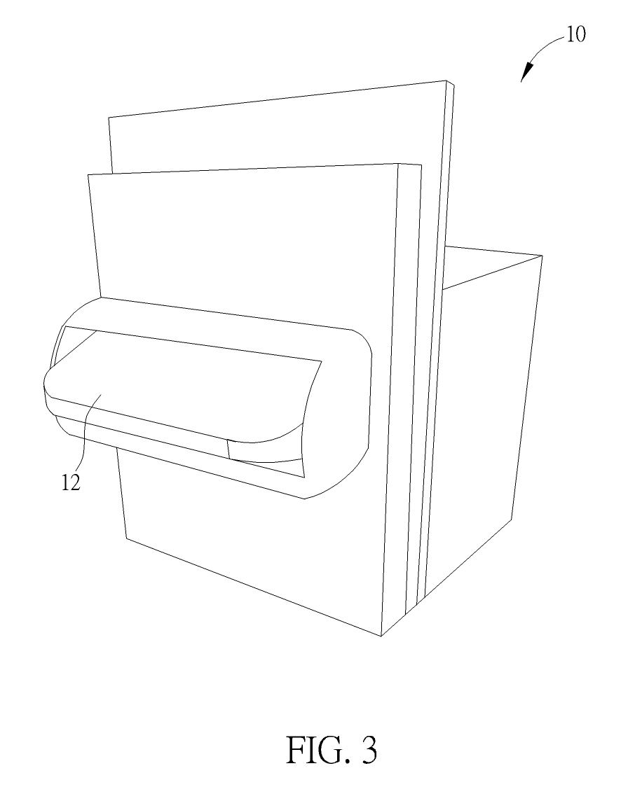

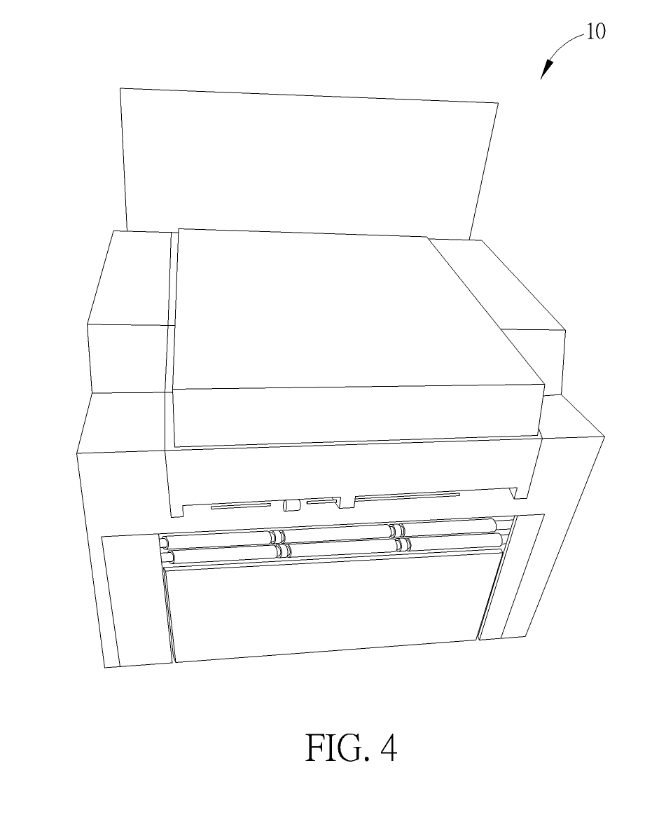

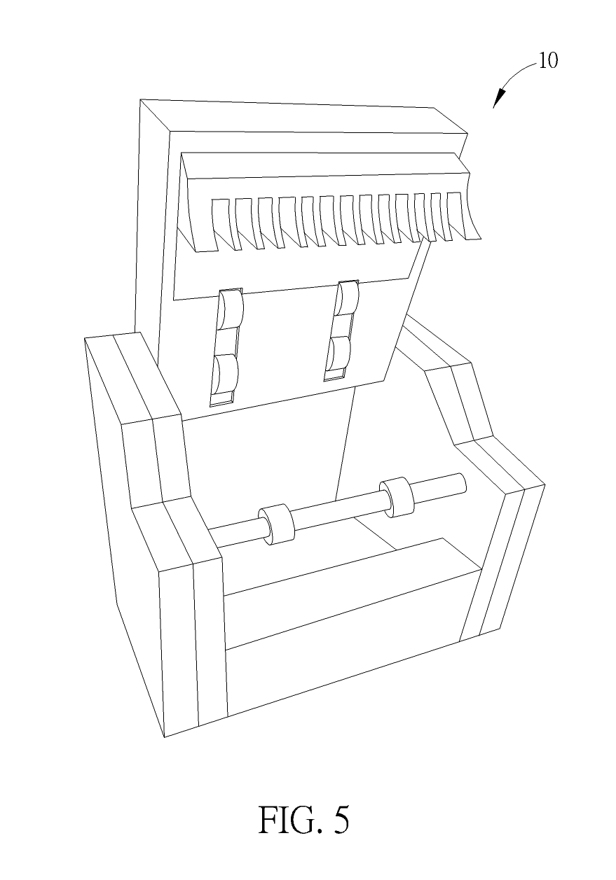

Please refer to FIG. 3 through FIG. 5. FIG. 3 is a diagram showing a front-right view of the bill acceptor 10 according to a first embodiment the present invention. A bill is inserted through the single bill acceptor slot 12, and when the inserted bill is detected, the process for identifying the currency and the denomination of the inserted bill begins. FIG. 4 is a diagram showing a rearview of the bill acceptor 10 according to the first embodiment the present invention. FIG. 5 is a diagram showing a rear view of the bill acceptor 10 in which a top cover of the bill acceptor 10 is lifted according to the first embodiment the present invention.

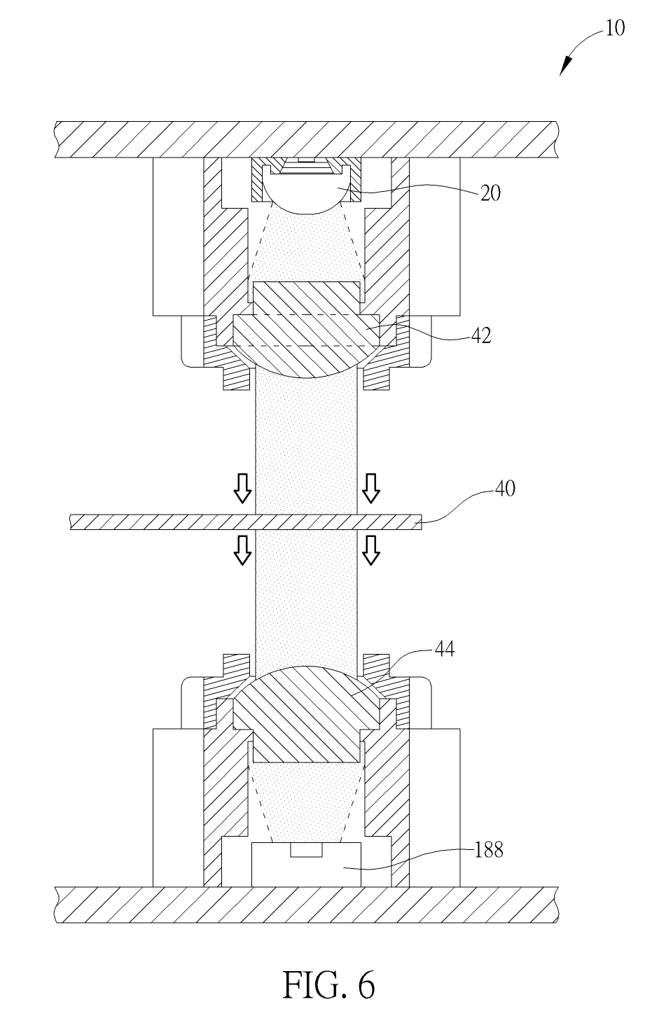

Please refer to FIG. 6. FIG. 6 is a structural diagram showing internal components of the bill acceptor 10 related to operation of the optical sensor 188 according to the first embodiment of the present invention. When an inserted bill 40 is scanned by the optical sensor 188, the plurality of light sources 20 are activated in turn for scanning the inserted bill 40 using different bands of visible and invisible light. For example, the different bands of visible light include red light having a wavelength of 615 nm to 635 nm, green light having a wavelength of 515 nm to 532 nm, and blue light having a wavelength of 460 nm to 475 nm. The different bands of invisible light include infrared light having a wavelength of around 850 nm and ultraviolet light having a wavelength of around 94 nm. Please note that these specific wavelengths are provided as examples only, and are not intended to limit the present invention.

The light emitted by the plurality of light sources 20 passes through a light collimating lens 42 for making rays of the emitted light substantially parallel to each other as the light penetrates through the inserted bill 40. After the light penetrates through the inserted bill 40 the light then passes through a condensing lens 44 for concentrating the light onto the optical sensor 188.

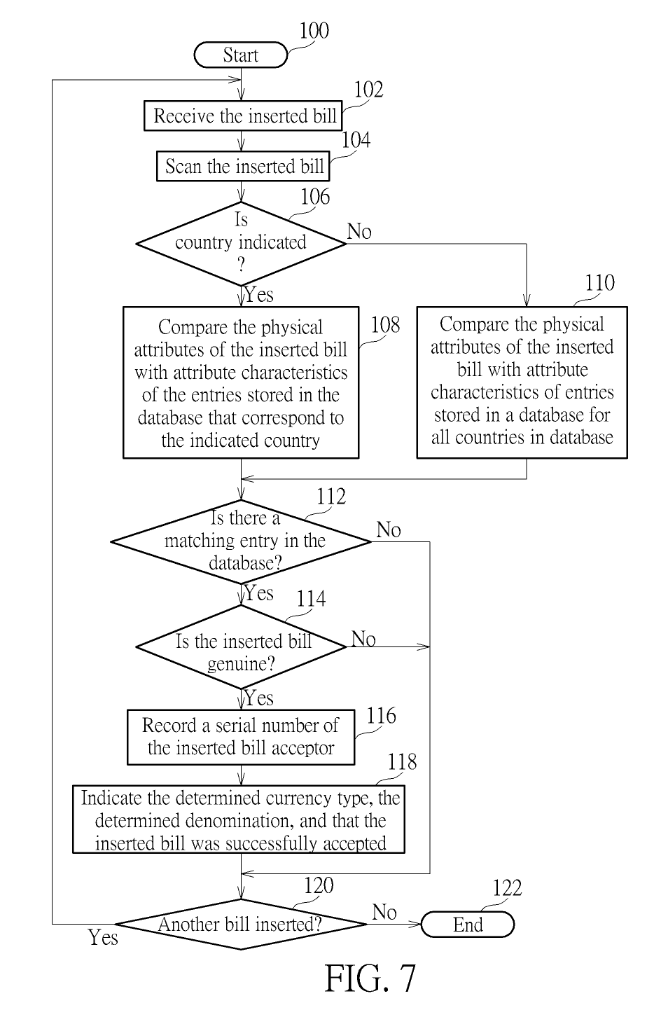

Please refer to FIG. 7. FIG. 7 is a flowchart describing the method of determining a currency type and a denomination of an inserted bill 40 that is inserted into the bill acceptor 10 according to the present invention. Steps in the flowchart will be explained as follows.

Step 100: Start.

Step 102: Receive the inserted bill 40 that is inserted into the single bill acceptor slot 12. The inserted bill 40 can be of any denomination and currency type that is supported by the bill acceptor 10. In this disclosure, each different currency type is defined as being currency from a unique country. For example, United States dollars and Euros are two distinct currencies. Examples of different denominations include $1, $5, $10, or $20.

Step 104: Scan the inserted bill 40 using the plurality of sensors 18 in conjunction with the plurality of light sources 20 to thereby determine physical attributes of the inserted bill 40.

Step 106: Determine if the user has provided input through the user interface 16 indicating a country that the inserted bill 40 corresponds to. For example the user may indicate that the country that the inserted bill 40 corresponds to is the United States. Specifying the country that the inserted bill 40 corresponds to will speed up and increase the accuracy of the search of the database 32. However, this is an optional step, and the user does not need to specify the country that the inserted bill 40 corresponds to in order for the inserted bill 40 to be properly identified. When the user indicates the country that the inserted bill 40 corresponds to, go to step 108. When the user does not indicate the country that the inserted bill 40 corresponds to, go to step 110.

Step 108: Compare the physical attributes of the inserted bill 40 with attribute characteristics of the entries stored in the database 32 that correspond to the indicated country. For example, if the user indicates that the country that the inserted bill 40 corresponds to is the United States, the physical attributes of the inserted bill 40 will only be compared with attribute characteristics of the entries stored in the database 32 for bills from the United States. Proceed to step 112.

Step 110: Compare the physical attributes of the inserted bill 40 with attribute characteristics of entries stored in a database 32 for all countries that have corresponding entries in the database 32. Although step 110 will take longer than step 108, it is still possible to accurately identify the inserted bill 40.

Step 112: Determine whether the inserted bill 40 has a matching entry in the database 32. If there is a match, go to step 114. If there is no match, go to step 120.

Step 114: Determine if the inserted bill 40 is genuine. Various methods can be used to determine if the inserted bill 40 is genuine, as known by a person skilled in the art of bill acceptors. For example, if a serial number of the inserted bill 40 is the same serial number that is known to be used on counterfeit bills, then the inserted bill 40 will be determined to be non-genuine and counterfeit. If the inserted bill 40 is determined to be genuine, go to step 116. If the inserted bill 40 is determined to be non-genuine, go to step 120.

Step 116: Record a serial number in the storage area for serial numbers 34 of the memory 30 of the bill acceptor 10. Along with the serial number, the determined currency type and the determined denomination of the inserted bill 40 can also be stored.

Step 118: Indicate the determined currency type, the determined denomination, and that the inserted bill 40 was successfully accepted.

Step 120: Determine if another bill is to be inserted into the bill acceptor 10. If more bills are to be inserted, go back to step 102. If not, go to step 122.

Step 122: End.

By accepting bills from multiple currencies, the present invention bill acceptor 10 can be used in a variety of applications. In the prior art, if a machine were to accept multiple currencies, then multiple bill acceptors would be needed, with one bill acceptor being dedicated to each currency type that the machine accepts. The present invention bill acceptor 10 simplifies the design of these machines by only requiring one bill acceptor 10 with the single bill acceptor slot 12 in order to accept bills of multiple currencies and multiple denominations.

One potential application of the present invention bill acceptor 10 is a currency exchange machine in which users can insert bills of a first currency and can exchange the inserted bills for bills of a second currency that are output from the currency exchange machine. Other applications include a vending machine that is capable of accepting multiple currencies, an automated teller machine (ATM) that allows users to make deposits using bills of a variety of different currencies, and a change machine that accepts bills in a variety of different currencies and provides change or tokens. The number of different applications of machines that can be built using the present invention bill acceptor 10 is virtually limitless since the bill acceptor 10 can be used in just about any machine that accepts money.

Machines that use the present invention bill acceptor 10 can be built less expensively than prior art machines with multiple bill acceptors since only the one bill acceptor 10 is needed. Less space is also needed for accommodating the bill acceptor 10. Furthermore, due to the flexibility and versatility of the bill acceptor, the bill acceptor can be updated in order to provide the ability to accept additional currencies, additional denominations, and new styles of bills in the future.

Those skilled in the art will readily observe that numerous modifications and alterations of the device and method may be made while retaining the teachings of the invention. Accordingly, the above disclosure should be construed as limited only by the metes and bounds of the appended claims.

1: A method of determining a currency type and a denomination of a bill inserted into a bill acceptor, the method comprising:
receiving the bill inserted into the bill acceptor, the bill acceptor being a single bill acceptor accepting bills of a plurality of currency types, wherein each currency type accepted by the bill acceptor is a currency from a unique country;
receiving input from a user indicating a country that the inserted bill corresponds to;
scanning the inserted bill after receiving the inserted bill and determining physical attributes of the inserted bill, wherein scanning the inserted bill comprises:
scanning the inserted bill with a dielectric sensor; and
generating a corresponding capacitance with the dielectric sensor when the inserted bill passes through charged plates of the dielectric sensor;
comparing the physical attributes of the inserted bill with attribute characteristics of entries stored in a database by comparing the physical attributes of the inserted bill with attribute characteristics of the entries stored in the database that correspond to the indicated country;
determining whether the inserted bill has a matching entry in the database;
determining the currency type and the denomination of the inserted bill upon determining that the inserted bill has the matching entry in the database; and
indicating the determined currency type, the determined denomination, and that the inserted bill was successfully accepted in response to determining that the inserted bill has the matching entry in the database.

2: The method of claim 1 further comprising recording a serial number of the inserted bill after determining that the inserted bill has the matching entry in the database.

3-4. (canceled)

5: The method of claim 1, wherein physical attributes of the inserted bill comprise physical dimensions of the inserted bill.

6: The method of claim 1, wherein physical attributes of the inserted bill comprise magnetic ink markings on the inserted bill.

7: The method of claim 1, wherein physical attributes of the inserted bill comprise color ink markings on the inserted bill.

8: The method of claim 1, wherein physical attributes of the inserted bill comprise fluorescent markings on the inserted bill or markings on the inserted bill that are sensitive to specific light bands.

9: The method of claim 1, wherein physical attributes of the inserted bill comprise watermarks on the inserted bill.

10: The method of claim 1, wherein physical attributes of the inserted bill comprise hidden characters on the inserted bill.

11: A multiple currency bill acceptor for determining a currency type and a denomination of an inserted bill, comprising:
a single bill acceptor slot receiving the inserted bill;
a user interface receiving input from a user indicating a country that the inserted bill corresponds to;
an optical sensor scanning the inserted bill after the single bill acceptor slot receives the inserted bill and determining physical attributes of the inserted bill, the optical sensor comprising a dielectric sensor that generates a corresponding capacitance when the inserted bill passes through charged plates of the dielectric sensor;
a memory containing a database storing entries of attribute characteristics corresponding to a plurality of currency types and denominations, wherein each currency type accepted by the bill acceptor is a currency from a unique country; and
a controller comparing the physical attributes of the inserted bill with attribute characteristics of the entries stored in the database by comparing the physical attributes of the inserted bill with attribute characteristics of the entries stored in the database that correspond to the indicated country, the controller indicating a determined currency type, a determined denomination, and that the inserted bill was successfully accepted in response to determining that the inserted bill has the matching entry in the database.

12: The multiple currency bill acceptor of claim 11, wherein the memory records a serial number of the inserted bill after the controller determines that the inserted bill has the matching entry in the database.

13-14. (canceled)

15: The multiple currency bill acceptor of claim 11, wherein physical attributes of the inserted bill comprise physical dimensions of the inserted bill.

16: The multiple currency bill acceptor of claim 11, wherein physical attributes of the inserted bill comprise magnetic ink markings on the inserted bill.

17: The multiple currency bill acceptor of claim 11, wherein physical attributes of the inserted bill comprise color ink markings on the inserted bill.

18: The multiple currency bill acceptor of claim 11, wherein physical attributes of the inserted bill comprise fluorescent markings on the inserted bill or markings on the inserted bill that are sensitive to specific light bands.

19: The multiple currency bill acceptor of claim 11, wherein physical attributes of the inserted bill comprise watermarks on the inserted bill.

20: The multiple currency bill acceptor of claim 11, wherein physical attributes of the inserted bill comprise hidden characters on the inserted bill.
